(19) United States
(12) Patent Application Publication
(10) Pub. No.: US 2005/0038136 A1
(43) Pub. Date: Feb. 17, 2005

(54) Process for producing inkjet ink composition and inkjet ink composition

(75) Inventors: Seiji Horie, Shizuoka (JP); Yutaka Sakasai, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/917,361

(22) Filed: Aug. 13, 2004

(30) Foreign Application Priority Data
Aug. 14, 2003 (JP) P.2003-293473

(51) Int. Cl. C09D 11/00; C03C 17/00

(52) U.S. Cl. 523/160; 106/31.6; 523/161

(57) ABSTRACT

A process for, producing an ink composition comprising a non-aqueous solvent, a, coloring material coated with a resin insoluble in the non-aqueous solvent and a dispersant, which comprises a first dispersion-treating step wherein the coloring material coated with the resin insoluble in the non-aqueous solvent is subjected to dispersion treatment together with the dispersant in the non-aqueous solvent at a dispersion liquid temperature of from 10° C. to less than 40° C., and a second dispersion-treating step wherein the dispersion liquid-obtained in the first dispersion-treating step is further subjected to dispersion treatment at a dispersion liquid temperature of from 40 to 60° C.

### FIELD OF THE INVENTION

The present invention relates to a process for producing an inkjet ink composition for forming letters or images on an ink receiving medium such as recording paper by ejecting ink and an inkjet ink composition. In particular, the invention relates to a process for producing an inkjet ink composition which can print dots having high-density and less blur at a high speed and stably and an inkjet ink composition.

### BACKGROUND OF THE INVENTION

Ink jet recording method of forming recorded dots by ejecting an ink to a recording medium to conduct printing has attracted attention as a non-impact recording method which enables coloration with ease and direct recording on plain paper, and various printers based on the method have been put into practice. As the ink jet recording system, there have been known on-demand ejection systems and continuous ejection systems, as described, for example, in Takeshi Agui, et al., Real Color Hard Copy, Sangyo Tosho Co., Ltd. (1993), Shin Ohno, Non-impact Printing—Technologies and Materials—, CMC Publishing Co., Ltd. (1986), and Takeshi Amari, Inkjet Printers—Technologies and Materials—, published by CMC Publishing Co., Ltd. (1998) Further, the continuous type includes electrostatic systems (Sweet type and Hertz type), and the on-demand type includes recording systems called a piezoelectric system, a shear mode piezoelectric system and a thermal inkjet system. As one of the on-demand type inkjet recording method, there is known, for example, a recording system called electrostatic acceleration type inkjet or slit jet as described, for example, in Susumu Ichinose and Yuji Ohba, Denshi Tsushin Gakkai Rombunnshi, Vol. J66-C (No. 1), p. 47 (1983), Tadayoshi Ohno and Mamoru Mizuguchi, Gazo Denshi Gakkaishi, Vol. 10 (No. 3), p. 157 (1981). In these systems, a voltage is applied across a plurality of recording electrodes disposed opposite to a recording medium and an counter electrode provided behind the recording medium, and the difference in potential generated between the both electrodes generates an electrostatic force acting on an ink supplied to the recording electrodes to eject the ink onto the recording medium. Specific embodiments thereof are disclosed, for example, in JP-A-56-170 (the term “JP-A” as used herein means an “unexamined published Japanese patent application”), JP-A-56-4467 and JP-A-57-151374. In these systems, a long and narrow slit-like ink-ejecting outlet section having many recording electrodes in the inside wall is used in place of nozzles in conventional inkjet heads, an ink is supplied into the slit-like ink chamber, and a high voltage is selectively applied to these electrodes, thereby ejecting the ink in the vicinity of the electrode to recording paper closely positioned to the slit-like head.

Thus, there exists less possibility of clogging of ink, and reduction in production cost can be expected due to the simple structure of the head and, in addition, the systems are advantageous for realizing a so-called long line head having an enough length to cover a wide range of a recording medium in the lateral direction.

One example of the drop-on-demand type full-color recording head based on such electrostatic acceleration type ink jet recording system is disclosed, for example, in JP-B-60-59569 (the term “JP-B” as used herein means an “examined Japanese patent publication”) and Denshi Tsusin Gakkai Rombunshi, Vol. J-68-C, 2 (1985), pp. 93-100.

In the electrostatic acceleration type inkjet head, an oil-based ink wherein a dye is dissolved in an organic solvent is preferably used. In the example shown in the following non-patent literature 6, an ink is used which has a volume resistivity (electric resistivity) of 10⁷ to 10⁸ Ω·cm, a surface tention of 22 mN/m, and a viscosity of 3.1 to 6.9 cP, though details are not disclosed as to ink-constituting materials.

However, such oil-based ink has a smaller surface tension in comparison with an aqueous ink ordinarily used in other ink jet recording systems, and hence it shows such a large permeability into recording paper that, particularly in the case of printing on plain paper, reduction in printing density, blur and strike-through are liable to take place.

An electrostatic system of a coloring material concentration discharge type without using the slit-like recording head is disclosed in Patent Literature 1 (JP-A-9-193389) and Patent Literature 2 (JP-A-10-138493). In this system, a plurality of individual electrodes for allowing an electrostatic force to act on a coloring material component in ink are constituted of a control electrode plate composed of an insulating plate having a through-hole formed therein and a control electrode formed corresponding to the through-hole and a convex ink guide arranged in the substantially center position of the through-hole, the ink is carried on the surface of convex ink guide to an ink droplet ejecting position by a surface tension, and a prescribed voltage is applied to the control electrode to eject ink droplet to a recording medium, thereby conducting recording.

In the coloring material concentration discharge type electrostatic inkjet recording system, particles of the coloring material are collected to an ejecting outlet section by electrophoresis, and ink droplets are ejected in a highly concentrated state. Therefore, unlike in the case of the aforesaid system, the ink droplets are ejected in a state wherein the particles of coloring material are aggregated and the amount of liquid component is small, and not in a state wherein ink-constituting components are uniformly present in a large amount of liquid component, thus the above-described problems are resolved. In addition, use of a pigment as coloring material provides advantageous results with respect to water resistance and light resistance of printed images as well in comparison with conventional inkjet systems using a dye.

In the ink for the coloring material concentration discharge type electrostatic inkjet recording system, it is first required for the ink to have a sufficiently large volume resistivity in order to obtain good printing properties of having high printing density without blur and strike through. This permits the electric field generated by voltage applied across the recording electrode and the counter electrode to reach the particles of coloring material. In case where the volume resistivity of ink is too low, the ink-suffers injection of charge to acquire charge due to the voltage applied by the recording electrode, and the ink is liable to be ejected in a state of containing a large amount of a liquid component due to electrostatic repelling force. Next, the particles of coloring material are required to have a sufficient charge amount, i.e., to have a positive or negative high particle conductivity, because it is necessary to collect the particles of coloring material to the outlet section at a sufficient speed by electrophoresis.

In recent years, with an increase for high speed recording with high image quality, the coloring material concentration discharge type ink head as described above also requires a technique for printing a highly precise image at a high speed by ejecting fine ink droplets in which the coloring material is highly concentrated stably and at a high speed for a long period of time.

It has been confirmed that such printing performance of ink greatly depends upon physical properties of ink. In order to obtain sufficient printing performance, it is necessary in producing the ink to impart a high electric conductivity of 100 pS/cm or more to the particles of coloring material while maintaining volume resistivity of the ink composition at a high level preferably, for example, of 10⁸ Ω·cm or more, if the electric conductivity of the particles of coloring material is less than 100 pS/cm, the particles of coloring material can not be transferred to the ejecting outlet section, i.e., to the tip of ejection electrode, at a high speed by electrophoresis, and hence the particles of coloring material can not be supplied sufficiently, resulting in deterioration of aggregating properties of the particles of coloring material and reduction in ejection response frequency.

Further, in some cases, the particles of coloring material adhere and deposit on the ejection electrode due to weak repelling force between the surface of ejection electrode and the particles of coloring material, leading to unstable ejection. Thus, there arise problems that sufficient printing density cannot be obtained and that stable and high-speed printing cannot be conducted.

The particles of coloring material are preferably constituted by a coloring material such as pigment and a resin. Resins for coating the coloring material are desired (1) to sufficiently cover the surface of pigment particles to form a coloring material mixture and show a proper fluidity upon being heated, (2) to well disperse the particles of coloring material by covering the surface of the particles, (3) to be as transparent as possible, (4) to be fixed on a recording medium by fixing procedure to impart a sufficient scratch resistance and, with the ink for electrostatic inkjet recording, (5) to impart a positive or negative, high electrical conductivity to the particles of coloring material. The particles of coloring material comprising a coloring material coated with a resin can be formed by coating the coloring material with the resin to form a colored mixture, then dispersing the colored mixture in a non-aqueous solvent. Actually, however, ordinary dispersing procedure can generate coarse particles of the coloring material, or generate fine particles of the coloring material of 0.2 μm or less, and it is difficult to obtain particles of coloring material having an average particle size of from about 0.3 to about 4 μm with a uniform particle size and containing a small number of fine particles of 0.2 μm or less.
[Patent Literature 1] JP-A-9-193389
[Patent Literature 2] JP-A-10-138493

### SUMMARY OF THE INVENTION

An object of the invention is to provide a process for producing an inkjet ink composition which permits printing dots having high-density with less blur due to high positive specific conductivity of the particles of coloring material contained in the ink composition.

Another object of the invention is to provide a process for producing an inkjet ink composition which is excellent in drying property on a recording medium such as recording paper, water resistance and light fastness of a recorded image and has a high fixing property and excellent scratch resistance.

A further object of the invention is to provide a process for producing an inkjet ink composition which permits stable printing for a long period of time because the charge amount of the particles of coloring material can be stably kept for a long time.

As a result of intensive investigations for solving the above problems, the inventors have found that the problems can be solved by the following constitutions.

That is, the invention is as follows.

(1) A process for producing an ink composition comprising a non-aqueous solvent, a coloring material coated with a resin insoluble in the non-aqueous solvent and a dispersant, which comprises a first dispersion-treating step wherein the coloring material coated with the resin insoluble in the non-aqueous solvent is subjected to dispersion treatment together with the dispersant in the non-aqueous solvent at a dispersion liquid temperature of from 10° C. to less than 40° C., and a second dispersion-treating step wherein the dispersion liquid obtained in the first dispersion-treating step is further subjected to dispersion treatment at a dispersion liquid temperature of from 40 to 60° C.

(2) A process for producing an electrostatic inkjet ink composition comprising a non-aqueous solvent, a coloring material coated with a resin insoluble in the non-aqueous solvent, a dispersant and a charge-controlling agent, which comprises a first dispersion-treating step wherein the coloring material coated with the resin insoluble in the non-aqueous solvent is subjected to dispersion treatment together with the dispersant in the non-aqueous solvent at a dispersion liquid temperature of from 10° C. to less than 40° C., and a second dispersion-treating step wherein the dispersion liquid obtained in the first dispersion-treating step is further subjected to dispersion treatment at a dispersion liquid temperature of from 40 to 60° C.

(3) An inkjet ink composition, which comprises a non-aqueous solvent, a coloring material coated with a resin insoluble in the non-aqueous solvent and a dispersant, wherein particles of the coloring material coated with the resin insoluble in the non-aqueous solvent have an average particle size of from 0.3 to 4 μm and a proportion of particles of the coloring material having a particle size of 0.2 μm or less is 5% or less by volume.

(4) An electrostatic inkjet ink composition, which comprises a non-aqueous solvent, a coloring material coated with a resin insoluble in the non-aqueous solvent, a dispersant and a charge-controlling agent, wherein particles of the coloring material coated with the resin insoluble in the non-aqueous solvent have an average particle size of from 0.3 to 4 μm and the proportion of particles of the coloring material having a particle size of 0.2 μm or less is 5% or less by volume.

(5) The electrostatic inkjet ink composition as described in (4), wherein the ink composition has a volume resistivity of 10⁸ Ω·cm or more at 25° C. and particles in the ink composition has an electrical conductivity of 100 pS/cm or more.

### BRIEF DESCRIPTION OF THE DRAWINGS

FIG. 1 is a sectional view of an inkjet head including an ejection electrode corresponding to a recording dot.

FIG. 2 is a front view showing a construction of ejection electrode plates of a line scanning type multi-channel inkjet head.

### DETAILED DESCRIPTION OF THE INVENTION

The invention provides a process for producing an inkjet ink composition which permits printing dots having high-density with less blur due to high positive specific conductivity of the particles of coloring material contained in the ink composition.

Also, the invention provides a process for producing an inkjet ink composition which is excellent in drying property on a recording medium such as recording paper, water resistance and light fastness of a recorded image and has a high fixing property and excellent scratch resistance.

Further, the invention provides a process for producing an inkjet ink composition which permits stable printing for a long period of time because the charge amount of the particles of coloring material can be stably kept for a long time.

The invention will be described in detail below.

The non-aqueous solvent to be used in the invention is preferably a non-polar insulating solvent having a dielectric constant of from 1.5 to 20 and a surface tension of from 15 to 60 mN/m at 25° C. Also, those solvents that have a low toxicity, a low flammability and a low odor are preferred. Examples of such non-aqueous solvent include straight chain or branched aliphatic hydrocarbons, alicyclic hydrocarbons, aromatic hydrocarbons, petroleum naphthas and halogen-substituted products thereof. Specific examples thereof include hexane, octane, isooctane, decane, isodecane, decalin, nonane, dodecane, isododecane, Isopar E, Isopar G, Isopar H and Isopar L (manufactured by Exxon), Solutol (manufactured by Phillips Oil), IP Solvent (manufactured by Idemitsu Petrochemical Co., Ltd.), and peptroleum naphthas including S.B.R., Shellsol 70 and Shellsol 71 (manufactured by Shell Petrochemical) and Vegasol (manufactured by Mobil Oil). The solvents can be used individually or in combination.

The hydrocarbon solvents are preferably high-purity isoparaffinic hydrocarbons having a boiling point in the range of from 150 to 350° C. Examples of commercially available products include Isopar G, Isopar H, Isopar L, Isopar M and Isopar V (trade names, manufactured by Exxon Chemical), Norpar 12, Norpar 13 and Norpar 15 (trade names, manufactured by Exxon Chemical), IP Solvent 1620 and IP Solvent 2028 (trade names, manufactured by Idemitsu Petrochemical Co., Ltd.), Isosol 300 and Isosol 400 (trade names, manufactured by Nippon Petrochemicals), and Amsco OMS and Amsco 460 solvents (trade names, manufactured by American Mineral Spirits Corp.). These products are composed of an aliphatic saturated hydrocarbon having an extremely high purity, and have a viscosity at 25° C. of 3 cSt or less, a surface tension at 25° C. of from 22.5 to 28.0 mN/m, and a volume resistivity at 25° C. of 10¹⁰ Ω·cm or more. Further, these products have characteristics such that they are stable due to low reactivity and are safe due to low toxicity and that their odors are low.

The halogen-substituted hydrocarbon solvents include fluorocarbon solvents. Examples thereof include perfluoroalkanes represented by CₙF₂ₙ₊₂, for example, C₇F₁₆ and C₈F₁₀ (for example, Fluorinert PF5080 and Fluoriner PF5070 (trade names, manufactured by Sumitomo 3M)), fluorine based inert liquids (for example, Fluorinert FC Series (trade names, manufactured by Sumitomo 3M)), fluorocarbons (for example, Krytox GPL Series (trade names, manufactured by DuPont Japan Ltd.)), fleons (for example, HCFC-141b (a trade name, manufactured by Daikin Industries, Ltd.), and iodinated fluorocarbons for example, F(CF₂)₄CH₂CH₂I and F(CF₂)₆I (for example, I-1420 and I-1600 (trade names, manufactured by Daikin Fine Chemical Laboratory, Ltd.)).

As the non-aqueous solvent that is used in the invention, higher fatty acid esters and silicone oils can also be used. Specific examples of the silicone oil include low-viscosity synthetic dimethylpolysiolxanes, which are commercially available, for example, KF96L (a trade name, manufactured by Shin-Etsu Silicone) and SH200 (a trade name, manufactured by Dow Corning Toray Silicone).

The silicone oils are not limited to these specific examples. As the dimethylpolysiloxanes, those having a very broad viscosity range are available depending on the molecular weight, but those having a viscosity at 25° C. in the range of from 1 to 20 cSt are preferably used. Similar to the isoparaffinic hydrocarbons, the dimethylpolysiloxanes have a volume resistivity at 25° C. of 10¹⁰ Ω·cm or more and have characteristics, for example, high stability, high safety and odorlessness. Further, the dimethylpolysiloxanes are characterized by a low surface tension, i.e., the surface tension is from 18 to 21 mN/m at 25° C.

Examples of solvents that can be used together with the above-described organic solvents include alcohols (for example, methyl alcohol, ethyl alcohol, propyl alcohol, butyl alcohol and fluorinated alcohol), ketones (for example, acetone, methyl ethyl ketone and cyclohexanone), carboxylic acid esters (for example, methyl acetate, ethyl acetate, propyl acetate, butyl acetate, methyl propionate and ethyl propionate), ethers (for example, diethyl ether, dipropyl ether, tetrahydrofuran, and dioxane), and halogenated hydrocarbons (for example, methylene dichloride, chloroform, carbon tetrachloride, dichloroethane and methylchloroform).

Now, the coloring material to be used in the invention will be described in detail below.

The coloring material is not particularly limited, and any ordinarily commercially available organic pigments and inorganic pigments, any dispersion of a pigment in a resin insoluble in the dispersing medium and any pigments having surface-grafted with a resin may be used. Also, those prepared by dyeing resin particles with a dye may be used.

Specific examples of organic pigments and inorganic pigments that exhibit yellow color include mono-azo pigments, for example, C.I. Pigment Yellow 1 (Fast Yellow G, etc.) and C.I. Pigment Yellow 74; dis-azo pigments, for example, C.I. Pigment Yellow 12 (Disazo Yellow AAA, etc.) and C.I. Pigment Yellow 17; non-benzidine based azo pigments, for example, C.I. Pigment Yellow 180; azo lake pigments, for example, C.I. Pigment Yellow 100 (Tartrazine Yellow Lake, etc.); condensed azo pigments, for example, C.I. Pigment Yellow 95 (Condensed Azo Yellow GR, etc.); acidic dye lake pigments, for example, C.I. Pigment Yellow 115 (Quinoline Yellow Lake, etc.); basic dye lake pigments, for example, C.I. Pigment Yellow 18 (Thioflavin Lake, etc.); anthraquinone based pigments, for example, Flavanthrone Yellow (Y-24); isoindolinone pigments, for example, Isoindolinone Yellow 3RLT (Y-110); quinophthalone pigments, for example, Quinophthalone Yellow (Y-138); isoindoline pigments, for example, Isoindoline Yellow (Y-139); nitroso pigments, for example, C.I. Pigment Yellow 153 (Nickel Nitroso Yellow, etc.); and metal complex azomethine pigments, for example, C.I. Pigment Yellow 117 (copper Azomethine Yellow, etc.).

Examples of coloring materials that exhibit magenta color include mono-azo pigments, for example, C.I. Pigment Red 3 (Toluidine Red, etc.), dis-azo pigments, for example, C.I. Pigment Red 38 (Pyrazolone Red B, etc.); azo lake pigments, for example, C.I. Pigment Red 53:1 (Lake Red C, etc.) and C.I. Pigment Red 57:1 (Brilliant Carmine 6B); condensed azo pigments, for example, C.I. Pigment Red 144 (Condensed Azo Lake BR, etc.); acidic dye lake pigments, for example, C.I. Pigment Red 174 (Phloxine B Lake, etc.); basic dye lake pigments, for example, C.I. Pigment Red 81 (Rhodamine 6G′ Lake, etc.); anthraquinone based pigments, for example, C.I. Pigment Red 177 (Dianthraquinonyl Red, etc.); thioindigo pigments, for example, C.I. Pigment Red 88 (for example, Thioindigo Bordeaux, etc.); perinone pigments, for example, C.I. Pigment Red 194 (Perinone Red, etc.); perylene pigments, for example, C.I. Pigment Red 149 (Perylene Scarlet, etc.); quinacridone pigments, for example, C.I. Pigment Red 122 (Quinacridone Magenta, etc.); isoindolinone pigments, for example, C.I. Pigment Red 180 (Isoindolinone Red 2BLT, etc.); and arizalin lake pigments, for example, C.I. Pigment Red 83 (Madder Lake, etc.).

Examples of pigments that exhibit cyan color include dis-azo pigments, for example, C.I. Pigment Blue 25 (Dianisidine Blue, etc.); phthalocyanine pigments, for example, C.I. Pigment Blue 15 (Phthalocyanine Blue, etc.); acidic dye lake pigments, for example, C.I. Pigment Blue 24 (Peacock Blue Lake, etc.); basic dye lake pigments, for example, C.I. Pigment Blue 1 (Victoria Pure Blue BO Lake, etc.); anthraquinone based pigments, for example, C.I. Pigment Blue 60 (Indanthrone Blue, etc.); and alkali blue pigments, for example, C.I. Pigment Blue 18 (Alkali Blue V-5:1).

Examples of pigments that exhibit black color include organic pigments, for example, aniline black based pigments such as BK-1 (Aniline Black), iron oxide pigments, and carbon black pigments, for example, furnace black, lamp black, acetylene black and channel black. Specific examples of the carbon black pigments include MA-8, MA-10, MA-11, MA-100, MA-220 , #25, #40, #260, #2600, #2700B, #3230B, CF-9, MA-100R and MA-200RB manufactured by Mitsubishi Kagaku K.K., Printex 75 and Printex 90 manufactured by Degussa Co., and Monark 800 and Monark 1100 manufactured by Cabot CO. Also, metallic powders are employable for attaining color reproduction, for example, gold, silver or copper color.

As other pigments, processed pigments comprising pigment fine particles dispersed in a rosin ester resin or a vinyl chloride-vinyl acetate resin are commercially available and may be used as well. Specific examples of the commercially available pigments include Microlith pigments manufactured by Ciba Specialty Chemicals. Preferred examples of the processed pigment include Microlith-T pigment in which pigment is coated with a rosin ester resin.

In the invention, the concentration of coloring material (pigment) is in a range of preferably from 0.5 to 20% by weight, particularly preferably from 2 to 15% by weight, based on the total amount of the ink composition. A sufficient printing density can be obtained by adjusting the concentration of coloring material to 0.5% by weight or more. Also, stable ink ejection can be attained without serious increase in viscosity of the ink composition by adjusting the concentration of coloring material to 20% by weight or less.

Next, the resin insoluble in a non-aqueous solvent will be described below.

As the resin insoluble in a non-aqueous solvent, various known natural or synthetic resins may be used. Examples thereof include acrylic resin, epoxy resin, polyester resin, ethylene-vinyl acetate resin, vinyl chloride-vinyl acetate resin, styrene-butadiene resin and styrene-acrylic resin. As means for dispersing the pigments in these resins, various known methods as are employed in the process of producing toners for electrophotography may be employed.

As other pigments, particles of coloring material coated with a commercially available resin may be used. Specific examples thereof include aforesaid Microlith-T pigment comprising pigment particles coated with a rosin ester resin.

As the resin, resins having a segment solvating with a solvent, a segment hardly solvating with a solvent and a polar group-containing segment are preferred for the purposes of adsorbing on a pigment and having a function of well dispersing in a non-aqueous solvent. Examples of the monomer that solvates with a solvent after polymerization include lauryl methacrylate, stearyl methacrylate, 2-ethylhexyl methacrylate and cetyl methacrylate. Examples of the monomer that hardly solvates with a solvent after polymerization include methyl methacrylate, ethyl methacrylate, isopropyl methacrylate, styrene and vinyltoluene. Examples of the polar group-containing monomer include an acid group-containing monomers, for example, acrylic acid, methacrylic acid, itaconic acid, fumaric acid, maleic acid, styrenesulfonic acid and an alkali metal salt thereof and a basic group-containing monomer, for example, dimethylamonoethyl methacrylate, diethylaminoethyl methacrylate, vinylpyridine, vinylpyrrolidine, vinylpiperidine and vinyllactam.

The particles of coloring material comprising a pigment coated with a resin insoluble in a non-aqueous solvent (coloring material-containing resin particles) can be formed by coating a coloring material with a binder resin to prepare a colored mixture, and dispersing the colored mixture as fine particles in a non-aqueous solvent according to the dispersion treating step to be described hereinafter. First, the step of coating a coloring material with a binder resin to prepare a colored mixture is described. The colored mixture is prepared, for example, by the following methods.
(1) A method of melt-kneading a pigment (coloring material) and a binder resin at a temperature higher than the softening point of the binder resin in a kneading machine such as roll mill, Banbury mixer or kneader and, after cooling, pulverizing the mixture to obtain a colored mixture.
(2) A method of dissolving a binder resin in a solvent, adding thereto a coloring material, wet-dispersing the mixture in a ball mill, an attritor or a sand grinder, and evaporating the solvent to obtain a colored mixture or pouring the dispersion into a non-solvent for the aforementioned binder resin to obtain a precipitated mixture, and drying it to obtain a colored mixture.
(3) A method of kneading an aqueous paste (wet cake) of a pigment together with a resin or a resin solution and replacing water with the resin or the resin solution according to the flushing method, then removing water and the solvent by drying under reduced pressure to obtain a colored mixture.

Next, the above-described colored mixture is dry-pulverized, then subjected to the dispersing step of wet-dispersing the pulverized product together with a dispersant in a non-aqueous solvent, which step is the characteristic aspect of the invention and is described below.

The dispersing step of the invention has a first dispersion-treating step wherein the dispersion treatment is conducted at a temperature of the dispersion liquid of from 10° C. to less than 40° C., and a second dispersion-treating step wherein the dispersion liquid obtained in the first dispersion-treating step is further subjected to dispersion treatment at a dispersion liquid temperature of from 40 to 60° C.

The dispersing machine to be used in the dispersing step is not particularly limited, and any of commercially available dispersing machines may be used. Examples thereof include a ball mill, a sand mill and an attritor. In order to prevent evaporation of solvent, closed type dispersing machines are ordinarily used. As the sand mill, there are of vertical type and horizontal type. In the sand mill, a shaft equipped with discs or pins is rotated at a peripheral speed of from 3 to 15 m/s to perform dispersion. An ink composition can be obtained with a good efficiency by arranging several continuous sand mills in series and conducting dispersion with changing the size of media depending upon degree of dispersion. Also, in the case of dispersing a pigment having a large-size diameter using a continuous sand mill, pre-dispersion is necessary and, in this case, a disperser, a ball mill or a batch type sand mill is used as a pre-dispersing machine.

Examples of the horizontal sand mill include Dynomill, Dynomill ECM (manufactured by WAB, Switzerland), Pearl mill, DCP mill (manufactured by Drais, Germany), Agitator mill (Netzsch, Germany), Super mill (Susmeyer, Belgium), Cobol mill (Frema, Switzerland) and Spike mill (Inoue Seisakusho).

Examples of media for ball mill and sand mill to be used include media of various materials such as zirconia, titania, alumina, glass, steel and silicon nitride. The material of media is selected in view of specific gravity and abrasion resistance of media depending upon viscosity of dispersion liquid and degree of pre-dispersion.

The media size is not particularly limited and, for example, media of from about 0.1 mm to about 10 mm in diameter may be used. In general, use of media having a larger particle size results in a broader particle size distribution, and use of media having a smaller particle size tends to disperse to a smaller particle size. Also, packing ratio of media is not particularly limited, and is preferably from 50% to 90%. The packing ratio of media is in a close relation with dispersing ability, and it is known that, in general, a higher packing ratio can serve to more improve dispersing efficiency. In comparison with vertical type mills, horizontal type mills never cause the locking phenomenon of media at the start, and hence the packing ratio is preferably 80 to 85% based on the volume of vessel.

As has been described hereinbefore, the invention is characterized in that the colored mixture having been dry-pulverized is wet-dispersed (first dispersing treatment step) together with a dispersant in a non-aqueous solvent at a dispersion liquid temperature of from 10° C. to less than 40° C., then subjected to dispersion treatment at a dispersion liquid temperature of from 40 to 60° C. (second dispersing treatment step). The method for controlling the temperature of the dispersion liquid is not particularly limited and, for example, the temperature of the dispersion liquid can be controlled by providing a jacket around the dispersing machine and supplying a coolant such as cold water to the jacket, or by providing a heat exchanger on the outlet side of the dispersing machine, monitoring the temperature of dispersion liquid, and controlling the temperature of the coolant according to the change in temperature of the dispersion liquid.

In ordinary dispersion of pigments, the mixture generates heat due to shearing energy given by the dispersing machine, leading to an increase in temperature of the dispersion liquid. This tendency becomes remarkable as the concentration of dispersion liquid increases. In case when the temperature of the dispersion liquid is increased, appropriate dispersion conditions cannot be obtained and, at the same time, aggregation of the pigment particles is liable to be accelerated due to increase in Brownian motion of the particles. Therefore, it has been ordinarily conducted to depress generation of heat by cooling to thereby control temperature of the dispersion liquid to a proper temperature range thereby dispersing a pigment into fine particles. In contrast, in the invention, a pigment is subjected to thermal dispersion treatment, contrary to cooling treatment, at a temperature within a specific range to make particle size of the coloring material uniform. Thus, it has become possible to provide an ink composition having excellent ejection stability, good dispersibility and providing images with excellent scratching resistance and fixability.

In the invention, the dispersion liquid temperature in the first dispersing treatment step is in a range of from 10° C. to less than 40° C., preferably from 15 to 35° C. Also, the dispersion liquid temperature in the second dispersing treatment step is in a range of from 40 to 60° C., preferably from 40 to 50° C. The dispersion liquid temperature in the second dispersing treatment step is preferably raised to a level 5° C. higher than the dispersion liquid temperature employed in the first dispersing treatment step by controlling, for example, temperature of the coolant. It is more preferred to conduct the second dispersing treatment at a temperature higher than that in the first dispersing treatment by 10° C. or more. As to a manner of raising the dispersion liquid temperature in the second dispersing treatment, the temperature may be raised at a time, or may be raised stepwise in a divided manner. The period of dispersion may be appropriately decided depending upon kind of starting materials and kind of dispersing machine, and is preferably, for example, from 2 to 12 hours.

The mechanism of how the effects of the invention are obtained is not clarified yet, but the inventors are considering as follows. That is, when the dispersion liquid temperature is increased in the second dispersing treatment step, the dispersion state of fine color material particles of 0.2 μm or less in particle size formed in the first dispersing treatment step becomes unstable due to desorption of the dispersant and, at the same time, fine particles of the coloring material aggregate or fuse to each other, or finer particles aggregate or fuse onto larger particles, due to softening of the coating resin, thus unification of coating and unification of particle size taking place.

The average particle size of coloring material particles formed is in a range of preferably from 0.3 to 4 μm, more preferably from 0.3 to 3 μm, particularly preferably from 0.4 to 2 μm. Also, the proportion of fine particles of coloring material having a particle size of 0.2 μm or less is preferably 5% or less, more preferably 4% or less, particularly preferably 3% or less, by volume.

In the dispersing treatment step, the dispersant is used in order to disperse the coloring material particles in the state of fine particles and to stabilize the dispersion in the non-aqueous solvent. Examples of the method of using the dispersant include the following.
1. A pigment composition previously prepared by mixing a colored mixture and the dispersant is added to a non-aqueous solvent, followed by dispersing the mixture.
2. A colored mixture and the dispersant are separately added to a non-aqueous solvent, followed by dispersing the mixture.

Any of them can provide intended effects.

As the pigment dispersant to be used in the invention, conventional pigment dispersants applied to the non-aqueous solvent may be used.

For example, any pigment dispersants can be used so far as they are compatible with the above-described non-aqueous solvent and can stably disperse the pigment in the state of fine particles. Specific examples of pigment dispersant include nonionic surfactants, for example, sorbitan fatty acid esters (e.g., sorbitan monooleate, sorbitan monolaurate, sorbitan sesquioleate and sorbitan trioelate), polyoxyethylene sorbitan fatty acid esters (e.g., polyoxyethylene sorbitan monostearate and polyoxyethylene sorbitan monooleate), polyethylene glycol fatty acid esters (e.g., polyethylene glycol monostearate and polyethylene glycol diisostearate), polyoxyethylene alkylphenyl ethers (e.g., polyoxyethylene nonylphenyl ether and polyoxyethylene octylphenyl ether), and aliphatic diethanolamides. Further, as high-molecular dispersants, high-molecular compounds having a molecular weight of 1,000 or more are preferable. Examples thereof include styrene-maleic acid resins, styrene-acrylic resins, rosins, BYK-160, BYK-162, BYK-164 and BYK-182 (urethane based high-molecular compounds manufactured by BYK-Chemie), EFKA-47 and LP-4050 (urethane based dispersants manufactured by EFKA), Solsperse 24000 (polyester based high-molecular compound manufactured by Zeneca PLC), and Solsperse 17000 (aliphatic diethanolamide based high-molecular compound manufactured by Zeneca PLC).

Other examples of the high-molecular pigment dispersant include random copolymers comprising a monomer that solvates with a solvent (for example, lauryl methacrylate, stearyl methacrylate, 2-ethylhexyl methacrylate and cetyl methacrylate), a monomer that hardly solvates with a solvent (for example, methyl methacrylate, ethyl methacrylate, isopropyl methacrylate, styrene and vinyltoluene) and a polar group-containing monomer, and the graft copolymers described in JP-A-3-188469. Examples of the polar group-containing monomer include an acid group-containing monomer, for example, acrylic acid, methacrylic acid, itaconic acid, fumaric acid, maleic acid, styrenesufonic acid and an alkali metal salt thereof, and a basic group-containing monomer, for example, dimethylamonoethyl methacrylate, diethylaminoethyl methacrylate, vinylpyridine, vinylpyrrolidine, vinylpiperidine and vinyllactam. In addition, styrene-butadiene copolymers, the block copolymers of styrene and a long chain alkyl methacrylate as disclosed in JP-A-60-10263 and the block copolymers disclosed in JP-A- 6-95436 are enumerated. Further, the graft copolymers disclosed in JP-A-4-350669 and JP-A-5-188657, the graft group-containing random copolymers soluble in a non-aqueous solvent disclosed in JP-A-11-43638, the partially crosslinked polymers disclosed in JP-A-10-316920 and the partially crosslinked polymers having a graft group at the terminal of the main chain as disclosed in JP-A-10-316920 are enumerated as pigment dispersants. Preferred examples of the pigment dispersant include the graft copolymers disclosed in JP-A-3-188469, JP-A-4-350669 and JP-A-5-188657. However, the pigment dispersants are not limited only to these.

The amount of the dispersant to be used in the dispersing step is preferably from 0.4 to 300 parts by weight, more preferably from 1.0 to 100 parts by weight, particularly preferably from 5 to 100 parts by weight, per 100 parts by weight of the colored mixture. The effect of dispersing pigment can be obtained by adding the dispersant in an amount of 0.1 part by weight or more, and the effect of reducing the proportion of fine particles can be obtained by adding the dispersant in an amount of 100 parts by weight or less.

As the charge-controlling agent which can be used in the invention, conventionally known ones may be used. Examples of usable charge-controlling agent include metal salts of fatty acids such as naphthenoic acid, octenoic acid, oleic acid and stearic acid, metal salts of a sulofocuccinate, the oil-soluble metal sulfonates disclosed in JP-B-45-556, JP-A-52-37435 and JP-A-52-37049, the metal phosphates disclosed in JP-B-45-9594, the metal salts of abietic acid or hydrogenated abietic acid disclosed in JP-B-48-25666, the Ca salts of alkylbenzenesulfonic acids disclosed in JP-8-55-2620, the metal salts of aromatic carboxylic or sulfonic acids disclosed in JP-A-52-107837, JP-A-52-38937, JP-A-57-90643 and JP-A-57-139753, nonionic surgfactants such as polyoxyethylated alkylamines, lecithin, oils and fats such as linseed oil, polyvinylpyrrolidone, organic acid esters of a polyhydric alcohol, the phosphate-based surfactants disclosed in JP-A-57-210345, and the sulfonic acid resins disclosed in JP-B-56-24944. Also, the aminoacid derivatives described in JP-A-60-21056 and JP-A-61-50951 may be used. Further, the copolymers containing a maleic acid half amide component, described in JP-A-60-173558 and JP-A-60-179750 are illustrated. Still further, the quaternized amine polymers disclosed in JP-A-54-31739 and JP-B-56-24944 can be illustrated.

Of these, preferred examples include metal salts of naphthenoic acid, metal salts of dioctylsulfosuccinic acid, copolymers containing the maleic acid half amide component, lecithin and the amino acid derivatives. These charge-controlling agents may be used in combination of two or more thereof. The concentration of the charge-controlling agent is preferably in a range of from 0.0001 to 2.0% by weight based on the total weight of the ink composition. A high specific conductivity can be imparted to the coloring material particles by using the charge-controlling agent in a concentration of 0.0001% by weight or more, and a necessary printing density can be maintained without reducing the volume resistivity of the ink composition by using the charge-controlling agent in a concentration of 2.0% by weight or more.

Fundamental constituents in the invention are as described hereinbefore, and various additives may be added, as needed, to the ink composition of the invention. Any of such additives may be selected depending upon type of inkjet recording system or inkjet ejecting head, ink-feeding section and material or structure of ink-circulating section, and may be contained in the ink composition. Examples of the additives which can be used include the additives described in Takeshi Amari, Inkjet Printers—Technologies and Materials—, chapter 17, published by CMC Publishing Co., Ltd. (1998).

Specific examples thereof include metal salts of fatty acids (e.g., monocarboxylic acids and polybasic acids having from 6 to 32 carbon atoms such as 2-ethylhexynoic acid, dodecenylsuccinic acid, butylsuccinic acid, 2-ethylcaproic acid, lauric acid, palmitic acid, elaidic acid, linolenic acid, ricinoleic acid, oleic acid, stearic acid, enanthic acid, naphthenic acid, ethylenediaminetetraacetic acid, abietic acid, dehydroabietic acid and hydrogenated rosin), resin acids, alkylphthalic acids and alkylsalicylic acids (examples of metal for metal ion: Na, K, Li, B, Al, Ti, Ca, Pb, Mn, Co, Zn, Mg, Ce, Ag, Zr, Cu, Fe and Ba), surface active compounds (e.g., organophosphoric acids or the salts thereof including mono, di- or tri-alkylphosphoric acids containing an alkyl group having from 3 to 18 carbon atoms, organosulfonic acids or the salts thereof including long-chain aliphatic sulfonic acids, long-chain alkylbenzenesulfonic acids, dialkylsulfosuccinic acids and the metal salts thereof, amphoteric surface active compounds including phospholipids such as lecithin and cephalin), surfactants having an alkyl group containing a fluorine atom- and/or dialkylsiloxan-bonded group, aliphatic alcohols (e.g., higher alcohols containing a branched alkyl group having from 9 to 20 carbon atoms, benzyl alcohol, phenethyl alcohol and cyclohexyl alcohol), polyhydric alcohols {e.g., alkylene glycols having from 2 to 18 carbon atoms (e.g., ethylene glycol, 1,2-propylene glycol, 1,3-propylene glycol, 1,4-butanediol, neopentyl glycol and 1,6-hexanediol, dodecanediol)}, alkylene ether glycols having from 4 to 1000 carbon atoms (e.g., diethylene glycol, triethylene glycol, dipropylene glycol, polyethylene glycol polypropylene glycol and polytetramethylene ether glycol), alicyclic diols having from 5 to 18 carbon atoms (e.g., 1,4-cyclohexanedimethanol and hydrogenated bisphenol A), adducts between an alkylene oxide having from 2 to 18 carbon atoms (e.g., ethylene oxide, propylene oxide, butylenes oxide or α-olefin oxide) and a bisphenol having from 12 to 23 carbon atoms (bisphenol A, bisphenol F and bisphenol S), polyols such as glycerin, trimethylolethane, trimethylolpropane, pentaerythritol and sorbitol, 3- to 8-hydric or more hydric phenols (e.g., trisphenol PA, phenol novolak and cresol novolak), adducts between the tri-hydric or more hydric polyphenol and an alkylene oxide having from 2 to 18 carbon atoms (addition mol number: 2 to 20), ether derivatives of the polyhydric alcohols (e.g., polyglycol alkyl ethers and alkylaryl polyglycol ethers), fatty acid ester derivatives of polyhydric alcohol, ether oleates of polyhydric alcohol (e.g., ethylene glycol monoethyl acetate, diethylene glycol monobutyl acetate, propylene glycol monobutyl propionate and sorbitan monomethyl dioxalate), alkylnaphthalenesulfonates and alkylarylsulfonates. These are not limitative at all. These additives are used in amounts so that the surface tension of the resulting ink composition falls within a range of preferably from 15 to 60 mN/m (at 25° C.) and the viscosity of the composition falls within a range of preferably from 1.0 to 40 cP.

The ink composition obtained by the invention is particularly useful as an ink for use in electrostatic inkjet recording devices. As the electrostatic inkjet printer, electrostatic inkjet printers based on any recording system may be used so long as an ink containing coloring material particles is used. Preferred examples thereof include electrostatic inkjet printers of the type ejecting the coloring material in a concentrated state. Additionally, in this embodiment, the volume resistivity of the ink composition at 25° C. is preferably 10⁸ Ω·cm or more, and the conductivity of the particles in the ink composition is preferably 100 pS/cm or more. Excellent printing performance can be imparted to the ink composition by meeting these conditions.

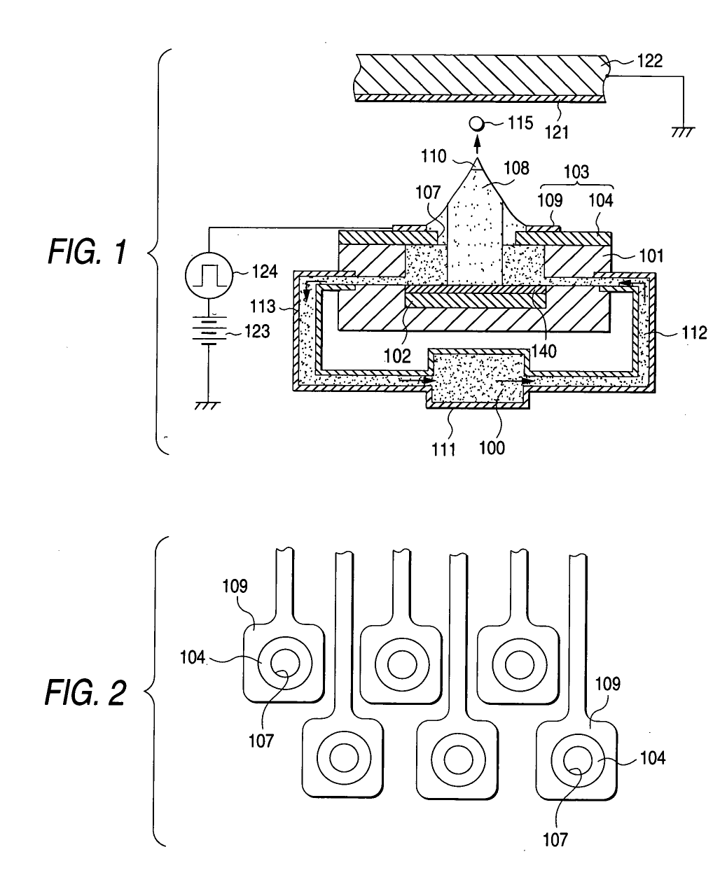

An electrostatic inkjet printers of the type ejecting the coloring material in a concentrated state is described in more detail below. FIGS. 1 and 2 are schematic views showing an embodiment of a discharge head. FIG. 1 is a view of inkjet head and particularly shows a cross-section of an ejection electrode corresponding to a recording dot. In FIG. 1, ink 100 is supplied from circulation mechanism 111 including a pump to a space between a head plate 102 and an ink-ejection electrode plate 103 through an ink supply passage 12 connected to a head block 101, and recovered to the ink-circulation mechanism 111 through an ink recovery passage 113 similarly formed in the head block 101. This ink-ejection electrode plate 103 is constructed of an insulating plate 104 having a through-hole 107 and an ejection electrode 109 formed around the through-hole 107 toward a recording medium. On the other hand, a convex ink guide 108 is disposed approximately in the center of the through-hole 107 on the head plate 102. This convex ink guide 108 is made of an insulating member such as a plastic resin or ceramics. Each convex ink guide is disposed at the line spacing and pitch so that the center thereof corresponds to the center of each through-hole 107, and kept on the head plate 102 by the prescribed method. Each convex ink guide 108 has a shape such that a tip of flat plate having a constant thickness is cut out into a triangular or trapezoidal shape, and the tip section thereof forms an ink droplet ejecting position 110. Each convex ink guide 108 may form a slit-like groove from its tip section, and ink supply into the ink-ejecting position 110 is smoothly conducted by capillarity of the slit, thereby enabling to enhance the recording frequency. Further, any surface of the ink guide may have conductivity as needed. In this case, by making the conductive portion in an electrically floating state, it is possible to effectively form an electrical field at the ink ejecting position by applying a low voltage to the ejection electrode. Each convex ink guide 108 protrudes approximately vertically from the corresponding through-hole by a prescribed distance in the direction of ink droplet ejection. A recording medium 121, for example, recording paper is placed toward the tip of the convex ink guide 108, and a counter electrode 122 which also functions as a role of platen guiding the recording medium 121 is disposed on the back surface of the recording medium 121 in relation to the head plate 102. Also, a migration electrode 140 is formed in the bottom portion of a space formed by the head plate 102 and the ejection electrode plate 103. By applying a prescribed voltage to the migration electrode 140, the charged particles in the ink are subjected to electrophoresis in the direction of ejecting position in the ink guide, thereby enabling to enhance responsibility of ejection. Next, a specific constructional embodiment of the ejection electrode plate 103 is described by reference to FIG. 2. FIG. 2 is a diagram of ejection electrode plate 103 viewed from the side of the recording medium 121, wherein a plurality of ejection electrodes are aligned in two lines in an array form in the main scanning direction, through-hole 107 is formed in the center of each ejection electrode, and the individual ejection electrode 109 is formed around the through-hole 107. In this embodiment, the inner diameter of the ejection electrode 109 is larger than the diameter of the through-hole 107, but it may be equal to the diameter of the through-hole 107. The insulating plate 104 is made of polyimide having a thickness of from about 25 to about 200 μm, the ejection electrode 109 is made of a copper foil having a thickness of from about 10 to about 100 μm, and the inner diameter of the through-hole 107 is from about 150 to about 250 μmφ.

Next, recording action of an inkjet recording device of electrostatic system is described below. Here, an embodiment where an ink containing negatively charged coloring material is used is described, but the invention should not be construed as being limited thereto. At the time of recording, the ink 100 supplied from the ink circulation mechanism 111 through the ink supply passage 112 is supplied into the ink ejecting position 110 of the tip of the convex ink guide 108 through the through-hole 107, and a part of the ink 100 is recovered in the ink circulation mechanism 111 through the ink recovery passage 113. A bias of, for example, −1.5 kV as a continuous bias is applied to the ejection electrode from a bias voltage source 123, and when turning on, a pulse voltage of −500 V as a signal voltage corresponding to an image signal from a signal voltage source 124 is superimposed to the ejection electrode 109. Further, during this period of time, a voltage of −1.8 kV is applied to the migration electrode 140. On the other hand, the counter electrode 122 provided on the back side of the recording medium 121 is set up at a ground voltage of 0 V as shown in FIG. 1. In some cases, the side of the recording medium-121 may be changed, for example, at −1.5 V for applying a bias voltage. In such a case, an insulating layer is provided on the surface of the counter electrode 122, the recording medium is charged by means of a corona charger, a scorotron charger or a solid ion generator, the ejection electrode 109 is, for example, grounded, and when turning on, a pulse voltage of −500 V as a signal voltage corresponding to an image signal from the signal voltage source 124 is superimposed to the ejection electrode 109. Further, during this period of time, a voltage of −200 V is applied to the migration electrode 140. When the ejection electrode 109 is in the turn-on state (in the state where −500 V is applied), and a voltage of −2 kV in total (the pulse voltage of −500 V is superimposed to the bias voltage of DC −1.5 kV) is applied, an ink droplet 115 is ejected from the ink ejecting position 110 of the tip of the convex electrode 108, drawn in the direction toward the counter electrode 122, and reaches the recording medium 121 to form an image. Additionally, in order to precisely control flight of the ink droplet after ejection to enhance dot placement accuracy on the recording medium, there are often taken measures, for example, provision of an intermediate electrode between the ejection electrode and the recording medium and provision of a guard electrode for suppressing electric field interference between the ejection electrodes. These may of course be employed as needed in the invention as well. Also, a porous body may be provided between the head plate 102 and the ejection electrode plate 103. In this case, not only influence by a change of ink inner pressure due to movement of the inkjet head, etc. can be prevented, but also ink supply into the through-hole 107 after ejection of the ink droplet can be rapidly achieved. Accordingly, ejection of the ink droplet 115 can be stabilized, whereby a good image having a uniform density can be recorded at a high speed on the recording medium 121.

The invention will be described in more detail with reference to the following examples, but the invention should not be construed as being limited-thereto.

### EXAMPLE 1

### Ink Composition IJ-1

100 Parts by weight of a blue pigment of Linol Blue FG-7350 (Pigment Blue 15:3; manufactured by Toyo Ink) and 200 parts by weight of a resin of styrene/vinyltoluene/lauryl methacrylate/butyl acrylate/trimethylammoniumethyl methacrylate (anion: p-toluenesulfonate ion) copolymer (25/27/2/27/18 by weight; weight-average molecular weight: 11,000) were preliminarily pulverized and well mixed in a trioblender, then melt-kneaded (120 minutes) in a 100° C.-heated desktop kneader PBV (manufactured by Irie Shokai). The resulting pigment mixture (colored mixture) was pulverized in a pin mill. Subsequently, 20 parts by weight of the pulverized pigment mixture, 93 parts by weight of Isopar G and 25 parts by weight of a 20% by weight solution prepared by dissolving the following pigment dispersant D-1 in Isopar G under heating were preliminary blended together with 400 parts by weight of 3G-X glass beads in a paint shaker (manufactured by Toyo Seiki Co., Ltd.) for 30 minutes. Then, the resulting mixture was subjected to wet dispersion treatment for 8 hours in a Dynomill KDL (manufactured by Sinmaru Enterprises) at a rotation number of 2,000 rpm while controlling the temperature of the dispersion liquid using a thermostatic chamber, NESLAB RTE7 (M&S Instruments Trading Inc.). First, dispersion treatment was conducted for 4 hours with controlling the temperature of the dispersion liquid at 25° C. The volume average particle size of resin-coated pigment particles (coloring material coated with a resin insoluble in a non-aqueous solvent) in the resulting dispersion liquid was measured by ultra-centrifugal automatic particle size distribution analyzer (CAPA700; manufactured by Horiba, Ltd.). As a result, it was found to be 0.49 μm. Also, the proportion of fine particles having a particle size of 0.2 μm or less was 8.7% by volume. Subsequently, dispersion treatment was conducted for further 4 hours with controlling the temperature of the dispersion liquid at 45° C. by raising the temperature of the medium of the thermostatic chamber. The volume average particle size of the resin-coated pigment particles in the resulting dispersion liquid was found to be 0.83 μm, and the proportion of fine particles having a particle size of 0.2 μm or less was 2.1% by volume.

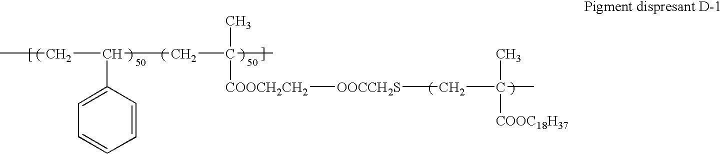

Copolymerization ratios are indicated by weight.

After separating the glass beads by filtration, the dispersion liquid of the resin-coated pigment particles was diluted with Isopar a to contain of 7.0% by weight of the component of the resin-coated pigment particles. Subsequently, octadecene-half maleic acid octadecylamide copolymer was added thereto as a charge-controlling agent to a concentration of 0.0054% by weight to prepare Ink composition IJ-1. The resulting ink composition had a viscosity of 1.32 cP (measured by an E-type viscometer at 25° C.), a surface tension of 23 mN/m (measured by an automatic surface tension meter manufactured by Kyowa Interface Science Co., Ltd. at 25° C.) and a relative dielectric constant of 2.19 (measured by LCR meter, AG-4311, manufactured by Ando Electronic Co., Ltd.). Also, the whole ink composition had a specific conductivity of 759 ps/cm, and a volume resistivity of 1.3×10⁹ Ω·cm at 25° C. The blue resin particles showing a distinct positive charge exhibited a particle conductivity of 695 pS/cm. Thus, it was found that most of the charge amount of the ink composition was kept on the resin-coated pigment particles. Also, it was found that, after incubation at 45° C. for one week, the specific conductivity of the whole ink composition and the particle conductivity of the resin-coated pigment particles were scarcely changed in their values and therefore that the ink composition was extremely stable.

The charge amount of the ink composition was determined based on the specific conductivity obtained by measuring under the conditions of 5 V in applied voltage and 1 kHz in frequency using the above-described LCR meter and electrodes for liquid (model LP-05 manufactured by Kawaguchi Electric Works Co., Ltd.), the particle conductivity of the resin-coated pigment particles was determined by subtracting the specific conductivity of a supernatant obtained by centrifugation of the ink composition from the specific conductivity of the whole ink composition, and the volume resistivity was obtained as a reciprocal number of the specific conductivity of the whole ink composition. The centrifugation was conducted at a rotation number of 14,500 rpm and at a temperature of 23° C. for 30 minutes using a small-sized high-speed cooling centrifuge (SRX-201 manufactured by Tomy Seiko Co., Ltd.).

An inkjet device equipped with 64-channel (100 dpi) electrostatic inkjet heads each having the structure as shown in FIG. 1 was used, and ink composition IJ-1 was charged in an ink tank thereof. After removing dusts on the surface of coated recording paper as a recording medium by air pump suction, the discharge heads were moved to a drawing position toward the coated recording paper and the ink was discharged at a drawing resolution of 600 dpi to draw an image. The drawing was conducted while changing dot areas at 16 stages in the dot size ranging from 15 μm to 60 μm by means of regulating the pulse voltage. The drawn image was stably printed with uniform dots without blur to provide a clear image of good quality having the satisfactory density. The ejection stability from ink head was good, no clogging occurred, and printing of stable dot form could be conducted in the continuous image drawing for a long period of time. Then, a full solid pattern was printed, and after drying and fixing the print, the solid portion thereof was subjected to the tape-peeling test. As a result, no peeled portion was found. Thus, the print was found to have extremely excellent scratching resistance and fixability.

Further, when the image drawing was conducted in the same manner except for using an ink composition after incubation at 45° C. for one week, the drawn image was stably printed with uniform dots without blur to provide a clear image of good quality having the satisfactory density. In addition, the ejection stability from ink head was good, and printing of stable dot form could be conducted in the continuous image drawing for a long period of time.

### COMPARATIVE EXAMPLE 1

### Comparative Ink Composition IJR-1

In the same manner as in Example 1 except for using a dispersion liquid of resin-coated pigment particles subjected to the first-step wet dispersion treatment and not subjected to the dispersion treatment by raising the medium temperature of the thermostatic chamber to prepare a diluted dispersion liquid having the content of the resin-coated particle component of 7.0% by weight and adding the charge-controlling agent (octadecene-half maleic acid octadecylamide copolymer) in an amount of 0.003% by weight, there was obtained comparative ink composition IJR-1.

The resulting comparative ink composition had a surface tension of 23 mN/m, a viscosity of 1.36 cP and a relative dielectric constant of 2.17. The whole ink composition had a specific electric conductivity of 813 pS/cm, and the conductivity of the particles was 763 pS/cm. When drawing performance of the comparative ink composition IJR-1 was evaluated in the same manner as in Example 1, it was found that ejection of the ink became unstable after continuously printing for one hour or shorter, and clogging of the head section occurred. This may be attributed to that, although the comparative ink composition IJR-1 had a large conductivity of coloring material particles, charge amount per coloring material particle was seriously reduced due to a large number of fine coloring material particles having a particle size of 0.2 μm or less, thus electrical migration properties of the coloring material particles being reduced, and hence supply of the coloring material particles became insufficient and good ejection performance was not obtained.

### EXAMPLE 2

### Ink Composition IJ-2

A press cake of Toner Cyan BG (manufactured by Clariant Co.) as a blue pigment and two-fold amount (in terms of the blue pigment) of a 33% toluene solution of a copolymer (styrene/vinyltoluene/lauryl methacrylate/trimethylammoniumethyl methacrylate (anion: p-toluenesulfonate ion) (29/66/2/3 by weight; weight-average molecular weight: 17,000) were stirred in a flusher, and heated and depressurized to remove water and the solvent to obtain a blue massive product containing 1% by weight of water. The blue massive product was dried in vacuo to completely remove water, then pulverized in a sample mill to obtain 0.1-0.01 mm blue powder.

Then, dispersion treatment was conducted in the same manner as in Example 1 for 2 hours with controlling the temperature of the dispersion liquid at 25° C. The volume average particle size of resin-coated pigment particles in the resulting dispersion liquid was found to be 0.45 μm, and the proportion of fine particles having a particle size of 0.2 μm or less was found to be 6.5% by volume. Subsequently, dispersion treatment was conducted for further 4 hours with controlling the temperature of the dispersion liquid at 55° C. by raising the temperature of the medium of the thermostatic chamber. The volume average particle size of the resin-coated pigment particles in the resulting dispersion liquid was found to be 0.89 μm, and the proportion of fine particles having a particle size of 0.2 μm or less was found to be 1.6% by volume.

The thus-obtained dispersion liquid of the resin-coated pigment particles was diluted with Isopar G to contain 7.0% by weight of the component of the resin-coated pigment particles. Subsequently, octadecene-half maleic acid octadecylamide copolymer was added as a charge-controlling agent thereto in a concentration of 0.060% by weight to prepare Ink composition IJ-2. The resulting ink composition had a surface tension of 23 mN/m, a viscosity of 1.48 cp and a relative dielectric constant of 2.32. The whole ink composition had a specific electric conductivity of 801 pS/cm, and a volume resistivity of 1.25×10⁹ Ω·cm at 25° C. The blue resin particles showing a distinct positive charge exhibited a particle conductivity of 614 pS/cm. Thus, it was found that most of the charge amount of the ink composition was kept on the resin-coated pigment particles. Also, it was found that, after incubation at 45° C. for one week, the specific conductivity of the whole ink composition and the particle conductivity of the resin-coated pigment particles were scarcely changed in their values and therefore that the ink composition was extremely stable.

when drawing performance of the ink composition IJ-2 was evaluated in the same manner as in Example 1, it was found that ejection stability of the ink from the ink heads was good and no clogging occurred and that, even after long-term continuous printing, printing was conducted with stable dot form. The resulting drawn image had sufficient density without blur and was clear and of good quality. Also, a full solid pattern was printed, and after drying and fixing the print, the solid portion thereof was subjected to the tape-peeling test. As a result, no peeled portion was found. Thus, the print was found to have extremely excellent scratching resistance and fixability.

Further, when the image drawing was conducted in the same manner except for using an ink composition after incubation at 45° C. for one week, the drawn image was a satisfactory image of uniform dots without blur.

### COMPARATIVE EXAMPLE 2

### Comparative Ink Composition IJR-2

In the same manner as in Example 2 except for using a dispersion liquid of resin-coated pigment particles subjected to the first-step wet dispersion treatment and not subjected to the dispersion treatment by raising the medium temperature of the thermostatic chamber to prepare a diluted dispersion liquid having the resin-coated particle component of 7.0% by weight and adding the charge-controlling agent (octadecene-half maleic acid octadecylamide copolymer) in an amount of 0.010% by weight, there was obtained comparative Ink composition IJR-2.

The resulting comparative ink composition had a surface tension of 23 mN/m, a viscosity of 1.32 cP and a relative dielectric constant of 2.18. The whole ink composition had a specific electric conductivity of 996 pS/cm, and the conductivity of the particles was 922 pS/cm. When drawing performance of the comparative ink composition IJR-2 was evaluated in the same manner as in Example 2, it was found that discharge of the ink became unstable after continuously printing for one hour or shorter, and clogging of the head section occurred.

### EXAMPLE 3

### Ink Composition IJ-3

100 Parts by weight of a blue pigment of Linol Blue FG-7350 (Pigment Blue 15:3; manufactured by Toyo Ink Manufacturing Co., Ltd.) and 200 parts by weight of a resin of polyester resin Vylon 220 (manufactured by Toyobo Co., Ltd.) were preliminarily pulverized and well mixed in a trioblender, then melt-kneaded (120 minutes) in a 100° C.-heated desktop kneader PBV (manufactured by Irie Shokai Co., Ltd). The resulting pigment mixture was pulverized in a pin mill. Subsequently, 20 parts by weight of the pulverized pigment mixture, 73 parts by weight of Isopar G and 50 parts by weight of a 20% by weight solution prepared by dissolving the following pigment dispersant D-2 in Isopar G under heating were preliminary blended together with 400 parts by weight of 3G-X glass beads in a paint shaker for 30 minutes. Then, the resulting mixture was subjected to dispersion treatment for 2 hours in a Dynomill KDL at a rotation number of 3,000 rpm while controlling the temperature of the dispersion liquid at 25° C. using a thermostatic chamber, NESLAB RTE7. The volume average particle size of resin-coated pigment particles in the resulting dispersion liquid was found to be 0.48 μm. Also, the proportion of fine particles having a particle size of 0.2 μm or less was 14.4% by volume. Subsequently, dispersion treatment was conducted for further 5 hours with controlling the temperature of the dispersion liquid at 50° C. by raising the temperature of the medium of the thermostatic chamber. The volume average particle size of the resin-coated pigment particles in the resulting dispersion liquid was found to be 0.71 μm, and the proportion of fine particles having a particle size of 0.2 μm or less was 0.9% by volume.

The thus-obtained dispersion liquid of the resin-coated pigment particles was diluted with Isopar G to contain 3.5% by weight of the component of the resin-coated pigment particles. Subsequently, octadecene-half maleic acid octadecylamide copolymer was added thereto as a charge-controlling agent to a concentration of 0.10% by weight to prepare Ink composition IJ-3. The resulting ink composition had a surface tension of 23 mN/m, a viscosity of 1.54 cp and a relative dielectric constant of 2.31. The whole ink composition had a specific electric conductivity of 573 pS/cm, and a volume resistivity of 1.75×10⁹ Ω·cm at 25° C. The blue resin particles showing a distinct positive charge exhibited a particle conductivity of 430 pS/cm. Thus, it was found that most of the charge amount of the ink composition was kept on the resin-coated pigment particles. Also, it was found that, after incubation at 45° C. for one week, the specific conductivity of the whole ink composition and the particle conductivity of the resin-coated pigment particles were scarcely changed in their values and therefore that the ink composition was extremely stable.

When drawing performance of the ink composition IJ-3 was evaluated in the same manner as in Example 1, it was found that ejection stability of the ink from the ink heads was good and no clogging occurred and that, even after long-term continuous printing, printing was conducted with stable dot form. The resulting drawn image had sufficient density without blur and was clear and of good quality. Also, a full solid pattern was printed, and after drying and fixing the print, the solid portion thereof was subjected to the tape-peeling test. As a result, no peeled portion was found. Thus, the print was found to have extremely excellent scratching resistance and fixability. Further, when the image drawing was conducted in the same manner except for using an ink composition after incubation at 45° C. for one week, the drawn image was a satisfactory image of uniform dots without blur.

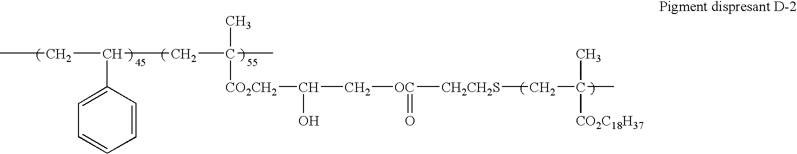

### COMPARATIVE EXAMPLE 3

### Comparative Ink Composition IJR-3

In the same manner as in Example 3 except for using a dispersion liquid of resin-coated pigment particles subjected to the first-step wet dispersion treatment and not subjected to the dispersion treatment by raising the medium temperature of the thermostatic chamber to prepare a diluted dispersion liquid having the content of the resin-coated particle component of 3.5% by weight and adding the charge-controlling agent (octadecene-half maleic acid octadecylamide copolymer) in an amount of 0.021% by weight, there was obtained Comparative ink composition IJR-3.

The resulting comparative ink composition IJ-3 had a surface tension of 23 mN/m, a viscosity of 1.53 cP and a relative dielectric constant of 2.30. The whole ink composition had a specific electric conductivity of 985 pS/cm, and the conductivity of the particles was 798 pS/cm. When drawing performance of the comparative ink composition IJR-3 was evaluated in the same manner as in Example 3, it was found that discharge of the ink became unstable after continuously printing for one hour or shorter, and clogging of the head section occurred.

### EXAMPLE 4

### Ink Composition IJ-4

Melt-kneading and preliminary pulverization were conducted in the same manner as in Example 3 except for using epoxy resin Epikote 1001 (Japan Epoxy Resins Co., Ltd.) as a resin. Then, the resulting mixture was subjected to dispersion treatment for 2 hours in a Dynomill KDL at a rotation number of 3,000 rpm while controlling the temperature of the dispersion liquid at 35° C. using a thermostatic chamber, NESLAB RTE7. The volume average particle size of resin-coated pigment particles in the resulting dispersion liquid was found to be 0.41 μm. Also, the proportion of fine particles having a particle size of 0.2 μm or less was 22.5% by volume. Subsequently, dispersion treatment was conducted for further 7 hours with controlling the temperature of the dispersion liquid at 50° C. by raising the temperature of the medium of the thermostatic chamber. The volume average particle size of the resin-coated pigment particles in the resulting dispersion liquid was found to be 0.76 μm, and the proportion of fine particles having a particle size of 0.2 μm or less was 2.8% by volume.

In the same manner as in Example 3, the thus-obtained dispersion liquid of the resin-coated pigment particles was diluted with Isopar G to contain 3.5% by weight of the component of the resin-coated pigment particles. Subsequently, octadecene-half maleic acid octadecylamide copolymer was added thereto as a charge-controlling agent to a concentration of 0.04% by weight to prepare Ink composition IJ-4.

The resulting ink composition had a surface tension of 23 mN/m, a viscosity of 1.46 cp and a relative dielectric constant of 2.31. The whole ink composition IJ-4 had a specific electric conductivity of 612 pS/cm, and a volume resistivity of 1.63×10⁹ Ω·cm at 25° C. The blue resin particles showing a distinct positive charge exhibited a particle conductivity of 469 pS/cm. Thus, it was found that most of the charge amount of the ink composition was kept on the resin-coated pigment particles. Also, it was found that, after incubation at 45° C. for one week, the specific conductivity of the whole ink composition and the particle conductivity of the resin-coated pigment particles were scarcely changed in their values and therefore that the ink composition was extremely stable.

When drawing performance of the ink composition IJ-4 was evaluated in the same manner as in Example 3, it was found that ejection stability of the ink from the ink heads was good and no clogging occurred and that, even after long-term continuous printing, printing was conducted with stable dot form. The resulting drawn image had sufficient density without blur and was clear and of good quality. Also, a full solid pattern was printed, and after drying and fixing the print, the solid portion thereof was subjected to the tape-peeling test. As a result, no peeled portion was found. Thus, the print was found to have extremely excellent scratching resistance and fixability. Further, when the image drawing was conducted in the same manner except for using an ink composition after incubation at 45° C. for one week, the drawn image was a satisfactory image of uniform dots without blur.

### COMPARATIVE EXAMPLE 4

### Comparative Ink Composition IJR-4

In the same manner as in Example 4 except for using a dispersion liquid of resin-coated pigment particles subjected to the first-step wet dispersion treatment and not subjected to the dispersion treatment by raising the medium temperature of the thermostatic chamber to prepare a diluted dispersion liquid having the content of the resin-coated particle component of 3.5% by weight and adding the charge-controlling agent (octadecene-half maleic acid octadecylamide copolymer) in an amount of 0.015% by weight, there was obtained Comparative ink composition IJR-4.

The resulting comparative ink composition IJ-4 had a surface tension of 23 mN/m, a viscosity of 1.65 cP and a relative dielectric constant of 2.14. The whole ink composition had a specific electric conductivity of 1069 pS/cm, and the conductivity of the particles was 1005 pS/cm. When drawing performance of the comparative ink composition IJR-4 was evaluated in the same manner as in Example 4, it was found that discharge of the ink became unstable after continuously printing for one hour or shorter, and clogging of the head section occurred.

It is seen from Examples 1 to 4 and Comparative Examples 1 to 4 that an ink composition obtained by subjecting to the first dispersing treatment step of dispersing in a non-aqueous solvent at a temperature in the range of from 10° C. to less than 40° C. and further to the second dispersing treatment step of dispersing at a temperature in the range of from 40 to 60° C. has coloring material particles having a uniform average particle size of from 0.3 to 4 μm, and the proportion of fine particles of the coloring material having a particle size of 0.2 μm or less is 5% or less by volume. Thus, it is seen that the ink composition has excellent ink ejection stability, good dispersibility, good scratch resistance and good fixability, and can provide good drawn images.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

1. A process for producing an ink composition comprising a non-aqueous solvent, a coloring material coated with a resin insoluble in the non-aqueous solvent and a dispersant, which comprises a first dispersion-treating step wherein the coloring material coated with the resin insoluble in the non-aqueous solvent is subjected to dispersion treatment together with the dispersant in the non-aqueous solvent at a dispersion liquid temperature of from 10° C. to less than 40° C., and a second dispersion-treating step wherein the dispersion liquid obtained in the first dispersion-treating step is further subjected to dispersion treatment at a dispersion liquid temperature of from 40 to 60° C.

2. A process for producing an electrostatic inkjet ink composition comprising a non-aqueous solvent, a coloring material coated with a resin insoluble in the non-aqueous solvent, a dispersant and a charge-controlling agent, which comprises a first dispersion-treating step wherein the coloring material coated with the resin insoluble in the non-aqueous solvent is subjected to dispersion treatment together with the dispersant in the non-aqueous solvent at a dispersion liquid temperature of from 10° C. to less than 40° C., and a second dispersion-treating step wherein the dispersion liquid obtained in the first dispersion-treating step is further subjected to dispersion treatment at a dispersion liquid temperature of from 40 to 60° C.

3. An inkjet ink composition, which comprises a non-aqueous solvent, a coloring material coated with a resin insoluble in the non-aqueous solvent and a dispersant, wherein particles of the coloring material coated with the resin insoluble in the non-aqueous solvent have an average particle size of from 0.3 to 4 μm and a proportion of particles of the coloring material having a particle size of 0.2 μm or less is 5% or less by volume.

4. An electrostatic inkjet ink composition, which comprises a non-aqueous solvent, a coloring material coated with a resin insoluble in the non-aqueous solvent, a dispersant and a charge-controlling agent, wherein particles of the coloring material coated with the resin insoluble in the non-aqueous solvent have an average particle size of from 0.3 to 4 μm and the proportion of particles of the coloring material having a particle size of 0.2 μm or less is 5% or less by volume.

5. The electrostatic inkjet ink composition as claimed in claim 4, wherein the ink composition has a volume resistivity of 10⁸ Ω·cm or more at 25° C. and particles in the ink composition has an electrical conductivity of 100 pS/cm or more.
